(19) United States
(12) Patent Application Publication
(10) Pub. No.: US 2008/0173600 A1
(43) Pub. Date: Jul. 24, 2008

(54) Holder for multiple beverage containers

(76) Inventor: Holly M. Mungal, Fort Lauderdale, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/656,260

(22) Filed: Jan. 22, 2007

(51) Int. Cl. A47G 29/00; F16B 47/00

(52) U.S. Cl. 211/71.01; 248/363

(57) ABSTRACT

A holder (1) for supporting multiple beverage containers includes a central support (70), for holding a first beverage container, a base (90), and a plurality of support arms (10, 20, 30, 40) connected to the base, a beverage container holding member (12, 22, 32, 42), and the central support about a periphery of the central support. One end of the support arm is connected to the beverage container holding member; the other end is connected to the base. Each support arm is connected to the central support at an intermediary point. In one embodiment, each beverage container holding member is arcuately shaped and contains a gap. The gap is sufficiently large to allow a stem of a second beverage container to pass through unobstructed and may be located opposite a connection point where the beverage container holding member connects to the support arm.

### CROSS-REFERENCE TO RELATED APPLICATIONS

This application claims priority under 35 U.S.C. § 120 upon U.S. application Ser. No. 29/268,996, which is entitled “Multiple Beverage Holder” and is incorporated herein by this reference.

### BACKGROUND OF THE INVENTION

1. Field of the Invention

The present invention relates generally to beverage holders and, more particularly, to an integrated holder for a beverage serving container, such as a wine bottle, and multiple individual beverage containers, such as wine glasses.

2. Description of the Prior Art

People often spend large amounts of time socializing on board recreational vehicles such as boats, motor-homes, tour buses, limousines, private aircraft, etc. At such social occasions, some form of food or beverage is typically served. Problems arise when the vehicle is in motion. Guests must either hold the serving container and/or glasses to prevent them from spilling or place them in some sort of cup holder. Unfortunately, typical cup holders do not function well when the glass is top-heavy, such as a wineglass or other stemware. The motion of the vehicle causes these types of glasses to tip over with extreme ease. Additionally, most cup holders are too small to hold a serving container, such as a bottle of wine or bucket of ice. In these instances, guests must resort to constantly holding their glasses down and are unable to free up their hands. People do not wish to be “glued to their glass”—specially while aboard a moving vehicle.

Additionally, when serving guests at a dinner or party, the appearance of the table setting, as well as the availability of space and functionality, is always a prime concern. For example, on many occasions, the quantity of food and beverage items presented on a table or other serving area is so vast that servers may have difficulty in finding a suitable location on the table for additional items. Additionally, when there are a large number of guests confined in a limited space, there is a tendency for tables to accidentally be bumped causing spills. If the table is overcrowded, bumping the table may cause glasses or other containers to fall off the edge and break.

Also troublesome is the display of beverage containers, especially wine or cocktail glasses. Quite often, a host will offer a selection of pre-filled glasses that are setup beside a wine bottle or other beverage container, enabling guests to take a fresh glass without waiting for a new glass to be filled or disturbing the general party atmosphere. Because the construction of a wine or cocktail glass is such that the beverage is contained in a bowl-like structure that sits atop a slender stem, these types of glasses are top heavy and are easily overturned.

Therefore, a need exists for, among other things, an integrated holder for a beverage serving container, such as a wine bottle, and multiple individual beverage containers that overcomes the shortcomings of the prior art.

### BRIEF DESCRIPTION OF THE DRAWINGS

FIG. 1 is a front, right perspective view of an integrated holder for a beverage serving container and multiple individual beverage containers in accordance with one embodiment of the present invention.

FIG. 2 is a front orthographic view of the multiple beverage container holder of FIG. 1.

FIG. 3 is a rear orthographic view of the multiple beverage container holder of FIG. 1.

FIG. 4 is a right side orthographic view of the multiple beverage container holder of FIG. 1.

FIG. 5 is a left side orthographic view of the multiple beverage container holder of FIG. 1.

FIG. 6 is a top plan view of the multiple beverage container holder of FIG. 1.

FIG. 7 is bottom plan view of the multiple beverage container holder of FIG. 1.

### DETAILED DESCRIPTION OF EXEMPLARY EMBODIMENT(S)

Before describing in detail exemplary embodiments that are in accordance with the present invention, it should be observed that the embodiments reside primarily in combinations of apparatus components related to implementing an integrated holder for a beverage serving container and multiple individual beverage containers. Accordingly, the components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

Generally, the present invention encompasses an integrated holder for a primary serving container and multiple individual serving containers. In one embodiment, the primary serving container is a beverage container (e.g., a wine bottle, a soda bottle, a water bottle, a pitcher, a keg, a bucket, or another container holding a beverage) and the multiple individual serving containers may be wineglasses or other stemware.

In accordance with one embodiment of the present invention, the holder provides a convenient and attractive apparatus for displaying a primary beverage container and multiple individual beverage containers. Each holder includes a central support for holding the primary beverage container, surrounded by multiple individual retainers for holding containers (e.g., cups, mugs, glasses, and stemware) intended for individual use. The central support is secured by the individual beverage retainers which are also connected to a base.

In another embodiment, each beverage retainer includes a beverage container holding member and a support arm which connects the central support to the base. The holding member may be arcuately shaped (e.g., arched or curved), with a gap, which is preferably located opposite the point where the beverage container holding member connects to the support arm, and is large enough to allow the stem of a wineglass (or other stemware) to pass through unobstructed. Additionally, the beverage container holding members are positioned above the base by enough vertical distance that when a wine glass is placed in the beverage container holding member, the stem of the wineglass does not touch the surface upon which the holder sits (e.g., a table or serving tray). In this manner, if the table is accidentally bumped, the shock of the bump is not transferred to the wineglass, which prevents the glass from tipping over.

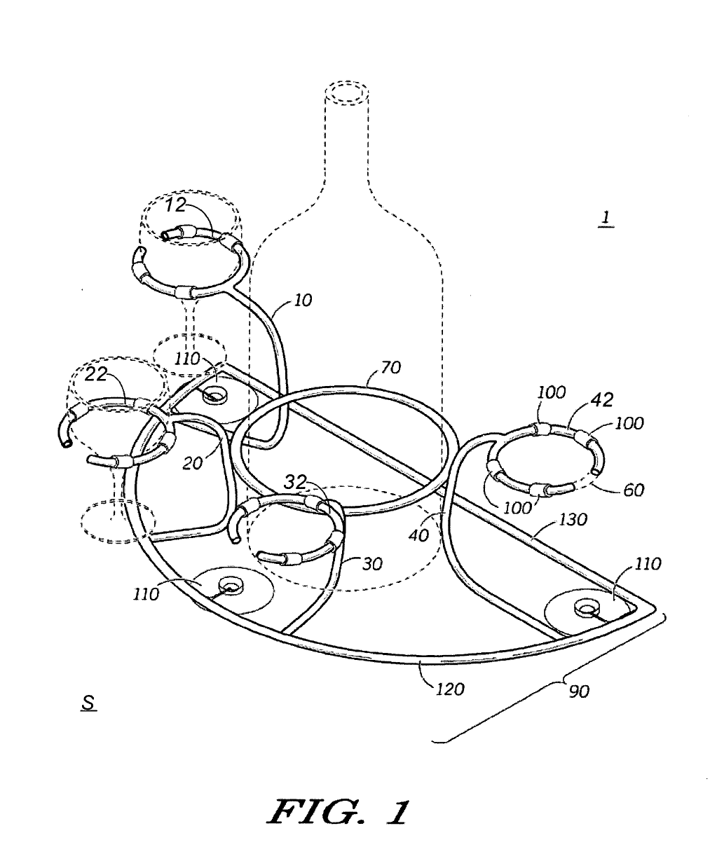

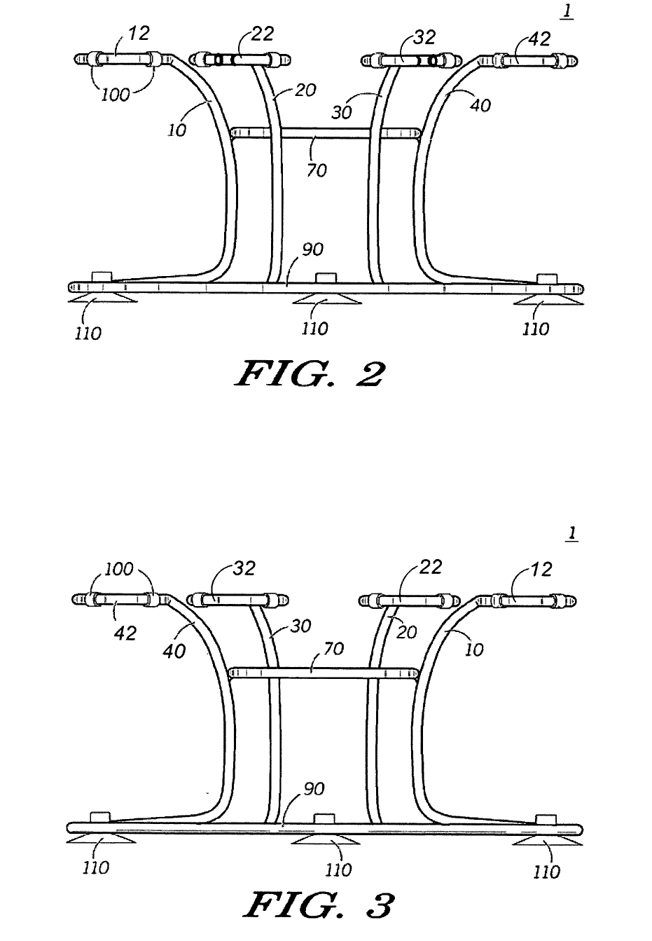

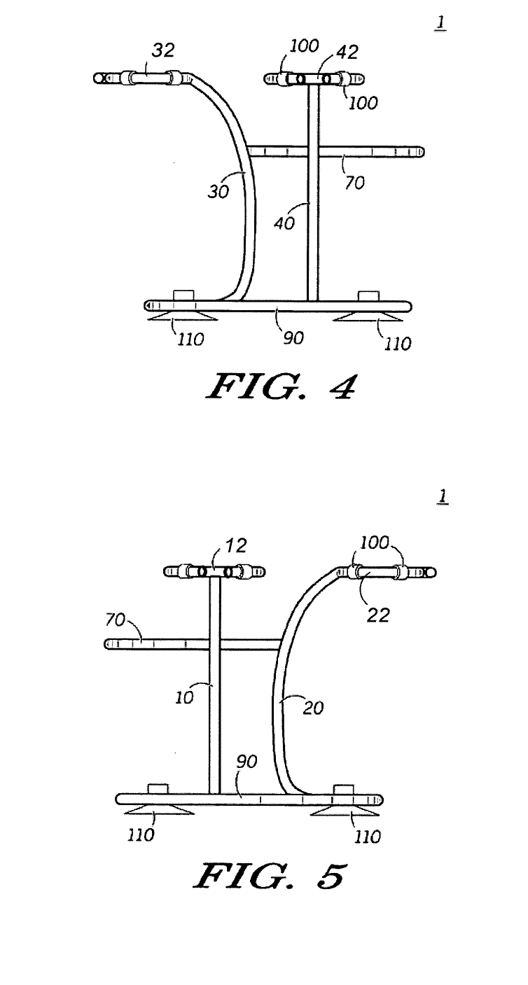

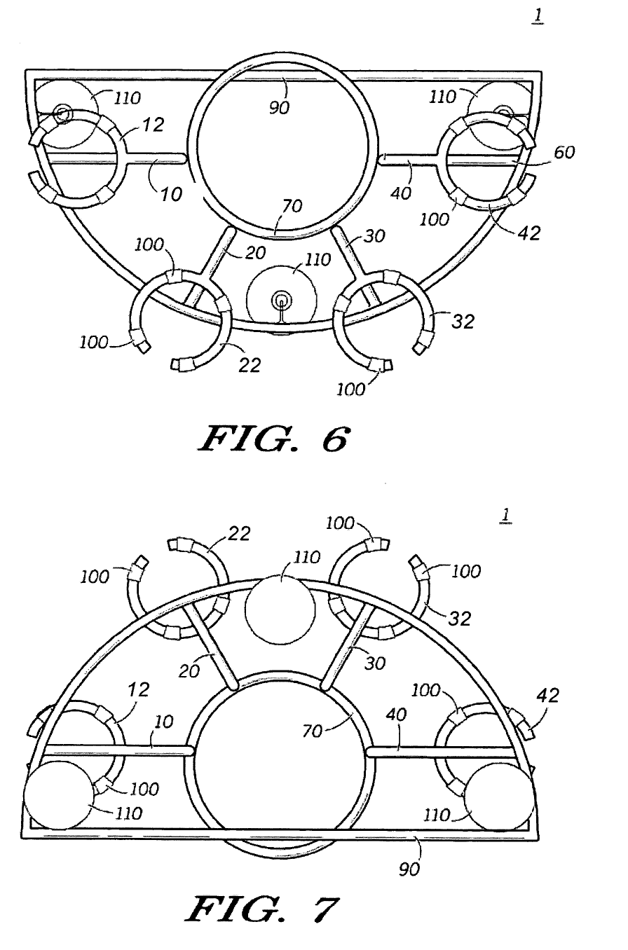

The preferred embodiment of present invention can be more readily understood with reference to FIGS. 1-7, in which like reference numerals designate like items. FIGS. 1-7 depict an exemplary integrated holder 1 for a primary serving container and multiple individual containers in accordance with a preferred embodiment of the present invention. For illustrative purposes, the primary serving container may be a beverage serving container (e.g., a wine bottle, a soda bottle, a water bottle, an alcoholic beverage bottle, a pitcher, a keg, a bucket, or any other container for holding beverages) and the multiple individual containers may be beverage containers (e.g., wineglasses, shot glasses, cups, mugs, glasses, etc.). The holder 1 includes a central support 70 surrounded by a plurality of support arms 10, 20, 30, 40, etc. (four shown) adapted to support a number of beverage container holding or retaining members 12, 22, 32, 42 and connected to a base 90. The sole means of support for the central support 70 is the plurality of support arms 10, 20, 30, 40 connected to the central support 70 about its periphery. The support arm 10, 20, 30, 40 connects the beverage container holding member 12, 22, 32, 42 to the central support 70 and to the base 90. The central support 70 preferably lies in a horizontal plane parallel to a surface S upon which the holder 1 rests. Because the central support 70 is supported exclusively by the plurality of support arms 10, 20, 30, 40 in the preferred embodiment, the central support 70 is located at a height beneath each beverage container holding member 12, 22, 32, 42. Additionally, the width of the central support 70, at its narrowest point, is greater than the outer diameter of the primary beverage serving container (e.g., wine bottle, etc.) to be held, such that the primary beverage serving container fits inside the central support 70, with the bottom of the primary beverage serving container preferably, but not by way of limitation, resting on the support surface S.

In a preferred embodiment, the holder 1 is constructed from a steel alloy. However, any other appropriate material, such as aluminum, cast iron, or plastic, may be used to form the holder 1. Each support arm 10, 20, 30, 40 may be welded, riveted, or otherwise releasably or fixedly fastened to the central support 70 and to the base 90. Additionally, finishing processes for the holder 1 may include painting, coating the underlying material with plastic, or electromagnetically applying a powder coat to the outer surface and then baking the holder 1.

In one embodiment, the holder 1 is designed to simultaneously support a wine bottle and multiple wineglasses, wherein each wineglass has a stem section for supporting the glass and a bowl section for holding liquid (e.g., wine or other beverage). In this embodiment, the beverage container holding member 12, 22, 32, 42 is arcuately shaped (e.g., curved or arched) and defines a gap 60 located opposite the point where the holding member 12, 22, 32, 42 connects to the support arm 10, 20, 30, 40. The gap 60 should preferably be sufficiently large to allow the stem portion of the wineglass to pass through unobstructed (e.g. ¼ inch to 2 inches wide). The beverage container holding member 12, 22, 32, 42 should be smaller, at its largest width, than the outer diameter of the bowl section of the wine glass, such that the bowl section rests on the beverage container holding member 12, 22, 32, 42 when inserted therein. In alternative embodiments, the beverage container holding member 12, 22, 32, 42 may be circular, oval, oblong, square, rectangular, octagonal, hexagonal, or any other shape configured to support a beverage container. Additionally, protective pads 100 may be positioned along the beverage container holding member 12, 22, 32, 42 helping to prevent the wineglass from slipping or breaking by coming into contact with the harder material of the beverage container holding member 12, 22, 32, 42. The protective pads 100 may be made from plastic, vinyl, rubber, or any other material adequate to isolate and/or cushion the fragile glass from the surface of the beverage container holding member 12, 22, 32, 42.

In another embodiment, each support arm 10, 20, 30, 40 is tall enough that when a wineglass is inserted into the beverage container holding member 12, 22, 32, 42 the wineglass does not touch the surface S (e.g., table, bar, or other serving area) upon which the base 90 rests. In other words, the height of the overall support arm 10, 20, 30, 40 is greater than the height of the stem section of the wineglass being supported. In this manner, the bowl section of the wineglass is upright and entirely supported by the beverage container holding member 12, 22, 32, 42. Thus, if a table or other support surface S upon which the holder 1 sits is accidentally bumped or moved, or if the recreational vehicle in which the holder 1 is located begins to move, the movement of the support surface S (which is preferably, but not by way of limitation, a table) is not directly transferred to the wineglass, thereby preventing the wineglass from tipping over.

At least one suction cup 110 may be connected to the base 90 which allows the holder 1 to be temporarily affixed to a horizontal surface (e.g., table, bar, countertop, cabinet, or other serving area). The suction cups 110 are located along the outer edge of the base 90 and are sufficient in size and number to prevent the holder 1 from slipping off the horizontal surface to which is attached. The suction cups 110 are essential to an embodiment of the present invention intended for use in a recreational vehicle.

Alternative embodiments allow the holder 1 to be used for other functions, such as serving food or ice. For example, the primary serving container may contain ice cubes for beverages and the multiple individual containers may be glasses. Other uses may include serving a dip in the primary serving container which sits upon the central support 70, surrounded by chips or vegetables in smaller individual bowls positioned in the holding members 12, 22, 32, 42.

As described above, the present invention encompasses an integrated holder for a primary serving container and multiple individual serving containers. With this invention, a primary serving container and a plurality of individual serving containers are displayed in a practical and attractive manner. An embodiment of the present invention occupies very little surface area, while helping to prevent accidental spills.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed:

1. A holder for supporting multiple beverage containers, the holder comprising:
a central support, for holding a first beverage container;
a base;
a plurality of beverage container holding members; and
a plurality of support arms connected to the base and the central support about a periphery of the central support, wherein each support arm includes a first end connected to one beverage container holding member of the plurality of beverage container holding members, a second end connected to the base, and an intermediary point connected to the central support.

2. The holder of claim 1 wherein each beverage container holding member is designed to support a wineglass, the wineglass having a stem section and a bowl section; and
each support arm having a height greater than a height of the wineglass stem section such that when the wineglass is placed in the beverage container holding member, the bowl section is supported entirely by the beverage container holding member in an upright position.

3. The holder of claim 1 wherein the central support is located in a horizontal plane at a height below each beverage container holding member of the plurality of beverage container holding members.

4. The holder of claim 1, wherein the central support, at its narrowest point, has a width greater than an outer diameter of the first beverage container.

5. The holder of claim 4 wherein the first beverage container is at least one of a wine bottle, a soda bottle, a water bottle, a pitcher, a keg, a bucket, and an alcoholic beverage bottle.

6. The holder of claim 1 wherein each beverage container holding member is arcuately shaped and terminates in a first end and a second end, the first end and the second end defining a gap.

7. The holder of claim 6 wherein a distance between the first end and the second end of the holding member is in the range of ¼ inch to 2 inches.

8. The holder of claim 6 wherein a distance between the first end and the second end of the holding member is sufficiently large to allow a stem of a second beverage container to pass through unobstructed.

9. The holder of claim 8 wherein the second beverage container is at least one of a wineglass and stemware.

10. The holder of claim 6 wherein the gap is located opposite a connection point where the beverage container holding member is connected to the support arm.

11. The holder of claim 6, further comprising:
a plurality of protection pads connected to each beverage container holding member.

12. The holder of claim 1 wherein each beverage container holding member is at least one of circular, oval, oblong, rectangular, square, octagonal, and hexagonal.

13. The holder of claim 1, further comprising:
at least one suction cup connected to the base, the suction cup for affixing the holder to a horizontal surface.

14. A holder for supporting multiple serving containers, the holder comprising:
a central support, for holding a primary serving container;
a base; and
a plurality of secondary serving retainers connected to the base and the central support about a periphery of the central support, wherein each secondary serving retainer includes:
a holding member; and
a support arm, the support arm including a first portion connecting the holding member to the central support and a second portion connecting the central support to the base.
